(19) United States
(12) Patent Application Publication
(10) Pub. No.: US 2016/0017709 A1
(43) Pub. Date: Jan. 21, 2016

(54) Anti-Friction Washer System

(71) Applicant: FCI Holdings Delaware, Inc., Wilmington, DE (US)

(72) Inventors: Travis Mikel Sub, Butler, PA (US); John C. Stankus, Canonsburg, PA (US); Thomas Cook, Washington, PA (US)

(21) Appl. No.: 14/798,767

(22) Filed: Jul. 14, 2015

Related U.S. Application Data
(60) Provisional application No. 62/026,098, filed on Jul. 18, 2014.

(51) Int. Cl. E21D 21/00; E21D 20/02; F16B 43/00

(52) U.S. Cl. CPC E21D 21/008; F16B 43/002; E21D 21/0086; E21D 20/025; E21D 21/0013; E21D 21/0093

(57) ABSTRACT

Included is an anti-friction washer system comprising two steel washers coated with a zinc coating that is at least 0.0002 inch thick, the two washers adhered to one another by an adhesive having a melting temperature of 300° F. or less. Also included is a mine roof bolt system comprising: a bolt having a bolt head; a bearing plate; and the above-described anti-friction washer system located between the bearing plate and the bolt head. Also included is a method of manufacturing an anti-friction washer system including providing two zinc-coated washers, depositing a melted thermoplastic adhesive in a plurality of locations circumferentially around one surface of one of the washers, placing the other washer on top of the adhesive, applying pressure to the washers, and cooling the bonded washers.

### CROSS-REFERENCE TO RELATED APPLICATION

The present application claims priority to U.S. Provisional Application No. 62/026,098, entitled “Anti-Friction Washer”, filed Jul. 18, 2014, the entire disclosure of which is hereby incorporated by reference.

### BACKGROUND OF THE INVENTION

1. Field of the Invention

The present invention relates to an anti-friction washer system. More particularly, it relates to an anti-friction washer system for use with a tensioned mine roof bolt.

2. Description of Related Art

A common mine roof bolt system used by the mining industry is a point-anchored, resin-assisted, fully tensioned bolt system. This system is typically comprised of headed rebar with a threaded expansion shell and plug assembly that is specifically designed to be used with resin. The bolt is installed with a bearing plate to support the roof strata. The bolt is tensioned by applying torque to the head of the bolt and tightening the shell and plug assembly. As the tension in the bolt increases, the laminated roof strata compresses across the entry, creating a beaming effect. During tensioning, friction is generated between the head of the bolt and the bearing plate. This friction reduces the amount of torque actually applied to the bolt, consequently reducing the amount of tension applied to the bolt.

The effectiveness of tensioned mine roof bolt systems has been well researched and documented over the years. Higher and more consistent installed tension has been shown to improve the beaming effect and associated roof stability especially in highly stressed, weak, laminated roof strata. To accomplish higher and more consistent bolt-installed tensions, various types of anti-friction washer systems have been developed and applied to many types of tensioned roof bolt systems. In addition to increasing bolt-installed tension, these washers also provide a lubricating effect that minimizes sparking during the bolt torquing cycle.

The most popular and widely used anti-friction washer system consists of a high density polyethylene (HDPE) plastic washer sandwiched between two hardened steel washers. The heat generated from rotational friction during installation softens the plastic washer creating a lubricating effect. This washer configuration has performed well in the field in terms of increasing the bolt-installed tension (or plate load) and the related tension/torque ratio (the amount of tension achieved per one ft-lb of applied torque). However, the installed tension is not always consistent. One reason for this inconsistency is that the plastic washer sometimes dislodges and shreds or tears before the bolt torquing cycle is complete. This condition prevents the plastic washer from acting as an anti-friction medium for the entire torquing cycle.

Therefore, there is a need for an anti-friction washer that provides both increased and consistent bolt-installed tension and tension/torque ratio.

### SUMMARY OF THE INVENTION

The present invention is directed to an anti-friction washer system comprising two steel washers coated with a zinc coating that is at least 0.0002 inch (0.005 mm) thick, the two washers adhered to one another by an adhesive having a melting temperature of 300° F. (149° C.) or less. The adhesive may be a thermoplastic adhesive, may comprise ethylene vinyl acetate, may have a melting point of less than 200° F. (93° C.), and/or may have a viscosity of 1500-1800 cps at 350° F. (177° C.). The mass of the adhesive may be 0.9-1.1 grams (0.031-0.039 ounce) and the thickness of the adhesive is 0.008-0.020 inch (0.2-0.5 mm).

The present invention is also directed to a mine roof bolt system comprising a bolt having a proximal end having a bolt head and a distal end, a bearing plate located at the proximal end of the bolt, and an anti-friction washer system located between the bearing plate and the bolt head. The anti-friction washer system comprises two steel washers coated with a zinc coating that is at least 0.0002 inch (0.005 mm) thick, the two washers adhered to one another by an adhesive having a melting temperature of 300° F. (149° C.) or less. The adhesive may be a thermoplastic adhesive, may comprise ethylene vinyl acetate, may have a melting point of less than 200° F. (93° C.), and/or may have a viscosity of 1500-1800 cps at 350° F. (177° C.). For each square millimeter of surface area of one side of one of the washers, 0.0105-0.0135 gram (0.00038-0.00048 ounce) of adhesive may be provided, and the thickness of the adhesive may be 0.008-0.020 inch (0.2-0.5 mm).

The present invention is also directed to a method of manufacturing an anti-friction washer system. In one embodiment, two zinc-coated washers are provided and a melted thermoplastic adhesive is deposited in a plurality of locations circumferentially around one surface of at least one of the washers. The other washer is then placed on top of the melted thermoplastic adhesive. Pressure is applied to the washers to bond the washers together, and the bonded washers are cooled. The washers may also be heated to less than 100° F. (38° C.) prior to application of the thermoplastic adhesive and pressure.

The thermoplastic adhesive may have a melting point of 300° F. (149° C.) or less and may have a total mass of 0.7-1.1 grams (0.025-0.039 ounce). The pressure may be 25-35 pounds force and may be applied for 1-5 seconds. The cooling may be forced air cooling.

### BRIEF DESCRIPTION OF THE DRAWINGS

FIG. 1 is a side perspective view of one embodiment of a mine roof bolt system according to the present invention expanded within the bore hole in a mine roof;

FIG. 2 is a side perspective view of one embodiment of an anti-friction washer system according to the present invention; and

FIG. 3 is a top view showing the deposition of the thermoplastic adhesive to one of the washers of the anti-friction washer system of the present invention.

### DESCRIPTION OF THE INVENTION

F or purposes of the following detailed description, it is to be understood that the invention may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Also, as used herein, units of force may be reported as “pounds” or “lbs.” or as “kilo newtons” or “kN”.

A common mine roof bolt system used by the mining industry is a point-anchored, resin-assisted, fully tensioned bolt system. Such a system is disclosed in U.S. Pat. No. 4,904,123, which is incorporated herein in its entirety.

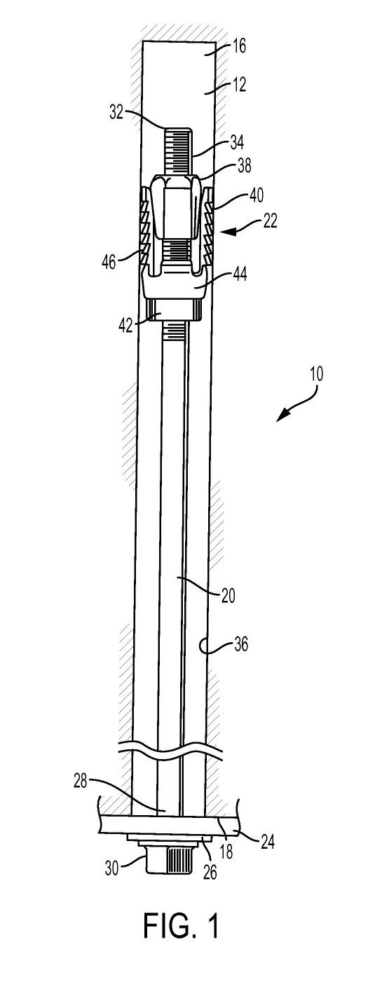

The mine roof bolt system 10 (FIG. 1) is adapted to be positioned within a bore hole 12 in a mine roof. The bore hole 12 has a blind end portion 16 and an open end 18 through which the mine roof bolt system 10 is inserted into the bore hole 12.

The mine roof bolt system 10 comprises a bolt 20, an expansion assembly 22, a bearing plate 24, and an anti-friction washer system 26.

The bolt 20 has a proximal end 28 having a bolt head 30 and a distal end 32 having a threaded end portion 34. As illustrated in FIG. 1, the bolt 20 has a smooth external surface; however, the bolt 20 may also be fabricated from a rebar with an irregular outer surface or may be a two-part bolt having one section that has a smooth external surface and one section that has an irregular external surface. The bearing plate 24 is positioned at the proximal end 28 of the bolt 20. The anti-friction washer system 26 is located between the bearing plate 24 and the bolt head 30.

The expansion assembly 22 which is secured to the threaded end portion 34 of the bolt 20 is adapted to engage a wall 36 of the bore hole 12. In one embodiment, the expansion assembly 22 has a tapered plug 38, an expansion shell 40, and a stop washer 42. The tapered plug 38 may be internally threaded so that it receives the threaded end portion 34 of bolt 20. The expansion shell 40 has a support ring 44 that encircles the bottom portion of the expansion shell 40. At least two expansion leaves 46 extend axially upwardly from the support ring 44. The expansion shell 40, which fits freely around the bolt 20, is supported on the bolt 20 by stop washer 42. Stop washer 42 is threadingly received on the threaded end portion 34 of the bolt 20. Other bolt expansion assemblies and/or bearing plates than those shown and described herein may be used with the anti-friction washer system 26 of the present invention.

Rotation of the bolt 20 relative to the tapered plug 38 and the expansion shell 40 moves the plug 38 downward relative to the expansion leaves 46, and engagement of the outer tapered surface of the plug 38 with the inner tapered surface of the expansion leaves 46 moves the expansion leaves 46 in a radially outward direction and into engagement with the bore hole wall 36 to tension the mine roof bolt system 10 within the bore hole 12. In addition, the bearing plate 24 and anti-friction washer system 26 that surround the bolt 20 at its proximal end 28 are drawn upwardly against the mine roof as the bolt 20 continues to be rotated and threaded through the tapered plug 38.

A resin cartridge (not shown) may be positioned in the blind end portion 16 of the bore hole 12. The resin cartridge contains a suitable resin in one compartment and a catalyst or hardener in a second compartment. Upon insertion, rotation of the bolt 20 prior to engagement of the expansion assembly 22 with the bore hole wall 36 fractures the cartridge and mixes the resin and catalyst so that the resin will harden and secure the mine roof bolt system 10 within the bore hole 12.

Other expansion shell assemblies may be used in the present invention including but not limited to a bail-type shell in which two expansion leaves are supported by a bail that extends over the end of the mine roof bolt. Such an expansion shell assembly is described in U.S. Pat. No. 5,076,733, which is incorporated herein in its entirety.

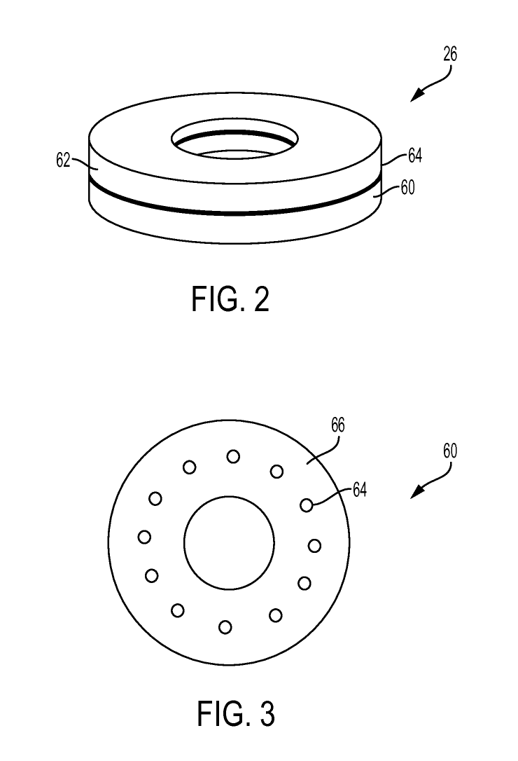

The anti-friction washer system 26 comprises two washers 60, 62 adhered to one another by an adhesive 64 as shown in FIG. 2.

The washers 60, 62 may be steel washers that have been hardened by heat treatment and then coated with a coating of zinc that is at least 0.0002 inch (0.005 mm) thick and preferably at least 0.0003 inch (0.008 mm) thick. The zinc coating may be applied using any suitable coating method including but not limited to electroplating followed by a 400° F. (204° C.) heat treatment to remove hydrogen. The zinc coating provides both corrosion protection and resistance to sparking during torquing. A passivation treatment to improve corrosion resistance may be applied to the zinc coating. Such passivation treatments include but are not limited to chromate passivation treatments, preferably trivalent chromate passivation treatments.

In one embodiment, the adhesive 64 is a thermoplastic adhesive, commonly known as a hot-melt adhesive, having a melting point of 300° F. (149° C.) or less, such as 200° F. (93° C.) or less. Thermoplastic adhesives are polymers which become pliable or moldable above a specific temperature and return to a solid state upon cooling. A lower melting point has been found to improve the functionality of the anti-friction washer system allowing the adhesive to activate earlier during the torquing process providing improved functionality of the anti-friction washer system.

The adhesive 64 may be an ethylene vinyl acetate (EVA) modified thermoplastic and may have a viscosity of 1500-1800 cps at 350° F. (177° C.). In one embodiment, the adhesive 64 has a slow speed of set, i.e., a slow rate at which the melted adhesive solidifies to the point where a functional self-supporting bond is obtained, a long open time, i.e., a long amount of time after deposition during which a bond can still be made, and an aggressive tack to provide for a robust manufacturing process. A suitable adhesive is HM132 EVA modified thermoplastic available from Pioneer Adhesive Products of America Corporation which has a melting point of 173° F. (78° C.).

The effectiveness of the anti-friction washer system is determined by evaluating the magnitude and the consistency of the installed load (tension) and the tension/torque ratio of the mine roof bolt system after installation with higher installed loads and higher tension/torque ratios being preferred.

The amount of adhesive directly affects the tension/torque ratio for the bolt. Table 1 reports tension/torque ratio test results for a bolt having the anti-friction washer of the present invention where the amount of adhesive for a given pair of steel washers having a 2.25 inch (57.2 mm) outer diameter and a 1.125 inch (28.6 mm) inner diameter.

TABLE 1

| Amount | | | | | |
|---|---|---|---|---|---|
| of | | Installed Load | | Torque | Tension/ |
| Adhesive | Test | (Tension) | | ft-lbs | Torque |
| (g) | Number | (kN) | (lbs) | (ft-lbs) | Ratio |
| <0.7 | 1 | 81 | 18,225 | 310 | 59 |
| | 2 | 70 | 15,750 | 310 | 51 |
| | 3 | 70 | 15,750 | 290 | 54 |
| | 4 | 86 | 19,350 | 340 | 57 |
| | 5 | 82 | 18,450 | 310 | 60 |
| | Average | 78 | 17505 | 312 | 56 |
| 1.0 | 1 | 102 | 22,950 | 270 | 85 |
| | 2 | 120 | 27,000 | 300 | 90 |
| | 3 | 102 | 22,950 | 270 | 85 |
| | 4 | 110 | 24,750 | 295 | 84 |
| | 5 | 90 | 20,250 | 250 | 81 |
| | Average | 105 | 23,580 | 277 | 85 |
| >1.2 | 1 | 95 | 21,375 | 353 | 61 |
| | 2 | 66 | 14,850 | 250 | 59 |
| | 3 | 70 | 15,750 | 206 | 76 |
| | 4 | 78 | 17,550 | 284 | 62 |
| | 5 | 87 | 19,575 | 320 | 61 |
| | Average | 79 | 17,820 | 283 | 64 |

As can be seen in Table 1, the installed load and the tension/torque ratio are significantly reduced when too much or too little adhesive is present. For the washers used in the tests reported in Table 1, if too much adhesive was applied (greater than 1.2 grams (0.042 ounce)), then, during the torquing process, the adhesive may not act as a lubricant. If too little adhesive was applied, both adhesion and lubrication may be poor. For these reasons, the amount of adhesive used with steel washers having a 2.25 inch (57.2 mm) outer diameter and a 1.125 inch (28.6 mm) inner diameter is between 0.9 gram (0.032 ounce) and 1.1 gram (0.039 ounce), resulting in a thickness of 0.008-0:020 inch (0.2-0.5 mm), and the amount of adhesive used with steel washers having a 2 inch (50.8 mm) outer diameter and a 1 inch (25.4 mm) inner diameter may be between 0.7 gram (0.025 ounce) and 0.9 gram (0.032 ounce), resulting in a thickness of 0.008-0.020 inch (0.2-0.5 mm). The amount of adhesive may be 0.0105-0.0135 gram per square millimeter of surface area of one side of one of the washers (4.61×10⁻⁴ oz./in²).

To manufacture the anti-friction washer system, the two washers may be heated to 90-100° F. (38° C.). Heating the washers above this temperature may affect the zinc coating which will in turn affect the bond between the washer, the zinc coating, and the adhesive. Adhesive that has been heated to 150-175° F. (66-79° C.) above its melting point is deposited on one surface 66 of one of the washers 60. For an adhesive having a melting point of 173° F. (78° C.), the adhesive is heated to 325° F. (162° C.). By heating the adhesive 64 to a temperature well above its melting point, maximum adhesion and lubricity are maintained. As shown in FIG. 3, the adhesive. 64 may be deposited in a plurality of locations circumferentially around the washer 60, while other configurations for the adhesive may be used as well. This may be accomplished using a multi-orifice nozzle and depositing the adhesive in all locations simultaneously or by rotating a single nozzle and/or the washer 60 as single drops of adhesive 64 are deposited. This assures uniform distribution of the adhesive 64 and helps to keep the adhesive 64 from squeezing out from between the washers 60, 62 before it solidifies.

The second washer 62 is then placed on top of the adhesive 64 and a pneumatic ram platen press may be used to apply 25-35 pounds (11-16 kg), preferably 30 pounds (14 kg), of force to the washer system for 1-5 seconds, preferably 2 seconds. The washer system is then cooled, such as by traveling over an 18 inch (45.7 cm) long track where it is exposed to forced air cooling via ambient air that is blown over the track. This air cooling takes approximately 1-5 seconds, such as 3-4 seconds.

Adhesive 64 is prevented from being squeezed out from between the washers 60, 62 by controlling: (a) the amount of adhesive 64 that is applied relative to the washer size (e.g., 0.9-1.1 grams (0.031-0.038 ounce) for washers having a 2.25 inch (57.2 mm) outer diameter, and a 1.125 inch (28.6 mm) inner diameter), (b) the temperature of the adhesive (150-175° F. (66-79° C.) above its melting point) and/or the washers (90-100° F. (32-38(66-79° C.)), and (c) the force applied during pressing (25-35 pounds force for 1-5 seconds).

### EXAMPLES

### Underground Testing Procedure

Normal installation procedures (excluding resin) were used to install test mine roof bolt systems, except that a calibrated Glotzel load cell was placed between two, 6 inch×6 inch (15 cm×15 cm) flat plates. The installation procedure consisted of drilling a 1⅜ inch (35 mm) diameter hole the same length as the completely assembled mine roof bolt system. The assembled mine roof bolt system was inserted into the drill hole. Then, the bolt was rotated using a bolting machine until snug against the roof, and the torquing process was continued until the bolting machine stalled. After installation, the installed load (tension) was recorded from the load cell. A calibrated torque wrench was used to measure the installed torque. The readings were then used to determine the installed load and tension/torque ratio for each test. The tension/torque ratio is the amount of bolt tension (lb.) obtained for each ft-lb of applied torque. After the readings were taken, the bolt was rotated counter-clockwise, and the mine roof bolt system, plates, and load cell were removed from the roof.

### Example 1

Example 1 was conducted in a room and pillar operation with a roof consisting of highly fractured and laminated dark shale strata. A video-scope examination confirmed that the roof strata was 5 feet, 7 inches (1.7 m) thick. The mine roof in this location is subjected to regional and localized horizontal stress and mining-induced stress from previous under-mining. Two-piece mine roof bolt systems with a 0.804 inch (20 mm) diameter bolt section having a rebar top section, a smooth-headed bar bottom section, a four-prong expansion shell, a roll pin coupler, and a round support nut were used for the testing. Mine roof bolt systems having the prior art anti-friction washer system comprising a high density polyethylene (HDPE) washer sandwiched between two hardened steel washers and mine roof bolt systems having the inventive anti-friction washer system were installed using the above-described underground testing procedure.

The mine roof bolt systems having the prior art anti-friction washer system produced an average installed load of 24,375 lb. (108 kN) and an average tension/torque ratio of 71:1 (Table 2). The mine roof bolt systems having the inventive anti-friction washer system produced an average installed load of 24,431 lb. (109 kN) and an average tension/torque ratio of 85:1 (Table 3). Thus, the inventive anti-friction washer system increased the tension/torque ratio by 20% over the prior art anti-friction washer. In addition, the performance consistency of the installed mine roof bolt systems with the inventive anti-friction washer system was much improved. The inventive anti-friction washer system produced a tension/torque ratio with a standard deviation of ±7.7 while the prior art anti-friction washer system produced a standard deviation of ±16.3. The more consistent installed load and tension/torque ratio achieved with the anti-friction washer system of the present invention as compared to the prior art systems significantly improves the beaming effect and roof stability in highly stressed and laminated roofs such as the one found in the strata of Example 1.

TABLE 2
Installed Load Test Data-Prior Art Anti-Friction
Washer System (Example 1)

| | Install | | Tension/ |
|---|---|---|---|
| | Load | Torque | Torque |
| Test Number | (lbs.) | (ft.-lbs.) | Ratio |
| 1 | 20,250 | 384 | 53 |
| 2 | 30,375 | 328 | 93 |
| 3 | 22,500 | 325 | 69 |
| Average | 24,375 | 345 | 71 |
| Standard Deviation ± | 4,341 | 27 | 16.30 |

TABLE 3
Installed Load Test Data-Inventive Anti-Friction
Washer System (Example 1)

| | Install | | Tension/ |
|---|---|---|---|
| | Load | Torque | Torque |
| Test Number | (lbs.) | (ft.-lbs.) | Ratio |
| 1 | 22,500 | 320 | 70 |
| 2 | 23,625 | 295 | 80 |
| 3 | 23,625 | 310 | 76 |
| 4 | 23,175 | 250 | 93 |
| 5 | 25,875 | 310 | 83 |
| 6 | 28,125 | 300 | 94 |
| 7 | 25,875 | 300 | 86 |
| 8 | 20,250 | 220 | 92 |
| 9 | 24,750 | 250 | 99 |
| 10 | 25,875 | 300 | 86 |
| 11 | 24,750 | 300 | 83 |
| 12 | 24,750 | 300 | 83 |
| Average | 24,431 | 288 | 85 |
| Standard Deviation ± | 1,921 | 29 | 7.72 |

### Example 2

Example 2 was conducted in a longwall mine operation with an immediate roof comprised of weak, laminated shale, sandy/shale, and coal bands. The roof strata is influenced by high regional horizontal stress. A video-scope analysis confirmed that the anchoring roof strata of 6 feet consisted of finely laminated sandy/shale. One-piece mine roof bolt systems with a 0.804 inch (20 mm) diameter bolt section having a single rebar bolt section and the same four prong expansion shell were used for the testing. Mine roof bolt systems having the prior art anti-friction washer system comprising a high density polyethylene (HDPE) washer sandwiched between two hardened steel washers and mine roof bolt systems having the inventive anti-friction washer system were installed in the development section of the longwall panel using the above-described underground testing procedure.

The four tests conducted with the prior art anti-friction washer system produced an average installed load of 18,113 lb. (81 kN) and an average tension/torque ratio of 57:1 (Table 4). The five installed load tests with the inventive anti-friction washer system produced an average installed load of 19,890 lb. (88 kN) and an average tension/torque ratio of 72:1 (Table 5). Compared to the prior art anti-friction washer system, this equates to a 10% increase in installed load and a 27% increase in the tension/torque ratio for the inventive anti-friction washer system. These higher values improve the beaming effect and roof stability, especially in high-stress, weak, laminated roofs such as the one found in the strata of Example 2.

TABLE 4
Installed Load Test Data-Prior Art Anti-Friction
Washer System (Example 2)

| | Install | | Tension/ |
|---|---|---|---|
| | Load | Torque | Torque |
| Test Number | (lbs.) | (ft.-lbs.) | Ratio |
| 1 | 16,875 | 290 | 58 |
| 2 | 18,450 | 350 | 53 |
| 3 | 20,250 | 325 | 62 |
| 4 | 16,875 | 310 | 54 |
| Average | 18,113 | 319 | 57 |
| Standard Deviation ± | 1,392 | 22 | 3.69 |

TABLE 5
Installed Load Test Data-Inventive Anti-Friction
Washer System (Example 2)

| | Install | | Tension/ |
|---|---|---|---|
| | Load | Torque | Torque |
| Test Number | (lbs.) | (ft.-lbs.) | Ratio |
| 1 | 18,000 | 250 | 72 |
| 2 | 16,200 | 250 | 65 |
| 3 | 23,625 | 280 | 84 |
| 4 | 19,575 | 290 | 68 |
| 5 | 22,050 | 300 | 74 |
| Average | 19,890 | 274 | 72 |
| Standard Deviation ± | 2680 | 21 | 6.73 |

### Example 3

Example 3 was conducted in a room and pillar operation that was experiencing abnormal roof conditions, such as roof sag and cutter. The mine roof strata is influenced by a high regional horizontal stress. One-piece mine roof bolt systems with a 0.804 inch (20 mm) diameter bolt section having a single rebar bolt section and the same four prong expansion shell were used for the testing. Mine roof bolt systems having the prior art anti-friction washer system comprising a high density polyethylene (HDPE) washer sandwiched between two hardened steel washers and mine roof bolt systems having the inventive anti-friction washer system were installed in Section #1, the mains, using the above-described underground testing procedure.

The seven tests conducted with the prior art anti-friction washer system produced an average installed load of 17,196 lb. (76 kN) and an average tension/torque ratio of 61:1 (Table 6). The seven tests conducted with the inventive anti-friction washer system produced an average installed load of 23,143 lb. (103 kN) and an average tension/torque ratio of 82:1 (Table 7). Compared to the prior art anti-friction washer system, this equates to a 10% increase in installed load and a 35% increase in the tension/torque ratio for the inventive anti-friction washer system. The higher values would improve the beaming effect and maximize the installed load for the bolt system.

TABLE 6
Installed Load Test Data-Prior Art Anti-Friction
Washer System (Example 3)

| | Install | | Tension/ |
|---|---|---|---|
| | Load | Torque | Torque |
| Test Number | (lbs.) | (ft.-lbs.) | Ratio |
| 1 | 15,750 | 285 | 55 |
| 2 | 18,000 | 290 | 62 |
| 3 | 15,750 | 240 | 66 |
| 4 | 18,000 | 265 | 68 |
| 5 | 19,125 | 305 | 63 |
| 6 | 20,250 | 300 | 68 |
| 7 | 13,500 | 300 | 45 |
| Average | 17,196 | 284 | 61 |
| Standard Deviation ± | 2,289 | 22 | 7.60 |

TABLE 7
Installed Load Test Data-Inventive Anti-Friction
Washer System (Example 3)

| | Install | | Tension/ |
|---|---|---|---|
| | Load | Torque | Torque |
| Test Number | (lbs.) | (ft.-lbs.) | Ratio |
| 1 | 22,500 | 285 | 79 |
| 2 | 30,375 | 285 | 107 |
| 3 | 20,250 | 275 | 74 |
| 4 | 22,500 | 325 | 69 |
| 5 | 19,125 | 250 | 77 |
| 6 | 24,750 | 250 | 99 |
| 7 | 22,500 | 325 | 69 |
| Average | 23,143 | 285 | 82 |
| Standard Deviation ± | 3,394 | 29 | 13.78 |

The inventive anti-friction washer system produced significantly higher and more consistent installed loads and torque/tension ratios in all case studies as compared to the prior art systems. The testing and underground observations indicate that, while the prior art anti-friction washer system provides some friction reducing effect, the bolt does not achieve its maximum installed load and consistency from bolt to bolt is poor. This is because the plastic washer of the prior art anti-friction washer system typically comes apart between the two hardened washers and ejects from the washers before the installation is complete, thereby preventing the plastic washer from functioning as an anti-friction medium for the complete bolt torquing process. This condition also creates steel-on-steel rotation that generates friction and sparks.

The inventive anti-friction washer system eliminates this condition because the polymer converts into a lubricant and remains between the washers during the entire installation. The combination of the zinc coating and the polymer lubricant produces a much better friction reducing medium.

Based on these results, the inventive anti-friction washer system can maximize the effectiveness of tensioned primary mine roof bolt systems because: 1) the higher and more consistent installed load and tension/torque ratio significantly improves the beaming effect and roof stability in a weak, high-stressed, and laminated roof; 2) the higher installed load increases the frictional resistance along laminated and weak bedding planes, making the strata less susceptible to horizontal-stress-induced lateral movement and the resultant roof weakening effect; 3) the zinc coating minimizes washer corrosion during shipping, handling, and storage of roof bolts; 4) the zinc coating eliminates potential sparking during the bolt rotation and torquing process; and 5) the inventive anti-friction washer system provides a very cost-effective way to maximize the performance of tensioned bolt systems.

Although the invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. An anti-friction washer system comprising two steel washers coated with a zinc coating that is at least 0.0002 inch thick, the two washers adhered to one another by an adhesive having a melting temperature of 300° F. or less.

2. The anti-friction washer system of claim 1, wherein 0.0105-0.0135 gram of adhesive is provided for each square millimeter of surface area of one side of one of the washers.

3. The anti-friction washer system of claim 1, wherein the adhesive comprises a thermoplastic adhesive.

4. The anti-friction washer system of claim 1, wherein the adhesive comprises ethylene vinyl acetate.

5. The anti-friction washer system of claim 1, wherein the melting point of the adhesive is less than 200° F.

6. The anti-friction washer system of claim 1, wherein the adhesive has a viscosity of 1500-1800 cps at 350° F.

7. The anti-friction washer system of claim 1, wherein the thickness of the adhesive is 0.2-0.5 mm.

8. A mine roof bolt system comprising:
a bolt having a proximal end having a bolt head and a distal end;
a bearing plate located at the proximal end of the bolt; and
an anti-friction washer system located between the bearing plate and the bolt head,
wherein the anti-friction washer system comprises two steel washers coated with a zinc coating that is at least 0.0002 inch thick, the two washers adhered to one another by an adhesive having a melting temperature of 300° F. or less.

9. The mine roof bolt system of claim 8, wherein 0.0105-0.0135 gram of adhesive is provided for each square millimeter of surface area of one side of one of the washers.

10. The mine roof bolt system of claim 8, wherein the adhesive is a thermoplastic adhesive.

11. The mine roof bolt system of claim 8, wherein the adhesive comprises ethylene vinyl acetate.

12. The mine roof bolt system of claim 8, wherein the melting point of the adhesive is less than 200° F.

13. The mine roof bolt system of claim 8, wherein the adhesive has a viscosity of 1500-1800 cps at 350° F.

14. The mine roof bolt system of claim 8, wherein the thickness of the adhesive is 0.2-0.5 mm.

15. A method of manufacturing an anti-friction washer system comprising:
providing two zinc-coated washers;
depositing a melted thermoplastic adhesive in a plurality of locations circumferentially around one surface of one of the washers;
placing the other washer on top of the melted thermoplastic adhesive;
applying pressure to the washers to bond the washers together; and
cooling the bonded washers.

16. The method of claim 15, wherein the thermoplastic adhesive has a melting point of 300° F. or less.

17. The method of claim 15, wherein the total amount of thermoplastic adhesive is 0.7-1.1 grams.

18. The method of claim 15, wherein the pressure is 25-35 pounds force and is applied for 1-5 seconds.

19. The method of claim 15, wherein the cooling is forced air cooling.

20. The method of claim 15 further comprising heating the washers to less than 100° F. prior to deposition of the thermoplastic adhesive and application of the pressure.
